(19) United States
(12) Patent Application Publication
(10) Pub. No.: US 2026/0163022 A1
(43) Pub. Date: Jun. 11, 2026

(54) TERMINAL PLATE FOR FUEL CELL

(71) Applicants: TOYOTA JIDOSHA KABUSHIKI KAISHA, Toyota-shi Aichi-ken (JP); AISIN TAKAOKA CO., LTD., Toyota-shi Aichi-ken (JP)

(72) Inventors: Katsuhiko KINOSHITA, Nisshin-shi Aichi-ken (JP); Hiroya NAKAJI, Toyota-shi Aichi-ken (JP); Kazuya MURATA, Okazaki-shi Aichi-ken (JP); Makoto TAKEDA, Toyota-shi Aichi-ken (JP); Tomoki TAMBO, Toyota-shi Aichi-ken (JP); Hideyuki ARAI, Seto-shi Aichi-ken (JP); Masakazu SUZUKI, Toyota-shi Aichi-ken (JP); Yoshiya TANAKA, Toyota-shi Aichi-ken (JP)

(73) Assignees: TOYOTA JIDOSHA KABUSHIKI KAISHA, Toyota-shi Aichi-ken (JP); AISIN TAKAOKA CO., LTD., Toyota-shi Aichi-ken (JP)

(21) Appl. No.: 19/408,642

(22) Filed: Dec. 4, 2025

(30) Foreign Application Priority Data
Dec. 10, 2024 (JP) 2024-215035

(51) Int. Cl. H01M 8/0247; H01M 8/0206; H01M 8/2457; H01M 8/2485

(52) U.S. Cl. CPC H01M 8/0247; H01M 8/0206; H01M 8/2457; H01M 8/2485; H01M 2250/20

(57) ABSTRACT

A terminal plate for fuel cell comprises: a plate body having a quadrilateral shape in a plan view and used for current collection; and a terminal provided at one side of the plate body, and including a joint part joined to the plate body and an output part joined to the plate body via the joint part. The joint part includes a first projection projecting in a first direction parallel to a direction in which the one side extends. The output part has a center in the first direction that is spaced apart from a center of the one side toward a second direction opposite to the first direction.

### CROSS REFERENCE TO RELATED APPLICATIONS

The present application claims priority from Japanese patent application 2024-215035 filed on Dec. 10, 2024, the disclosure of which is hereby incorporated in its entirety by reference into the present application.

### BACKGROUND

### Field

The present disclosure relates to a terminal plate for fuel cell.

### Related Art

Various techniques relating to a terminal plate for fuel cell have been suggested. As an example, Japanese Patent Application Publication No. 2019-114430 discloses a technique by which a terminal for outputting power generated by a fuel cell to the outside is joined to an outer periphery of a plate part.

When placing other components on the side where the terminals are located in a fuel cell, in order to minimize the overall space occupied by the fuel cell and the other components while suppressing contact between the terminals and the other components, inventors of the present disclosure attempted to position the terminal spaced apart from a center of the plate part in a longitudinal direction. A current in the plate part directed toward the terminal tries to flow along a shortest path. This causes concentration of the current at an end portion of the terminal in a direction opposite to that from the center of the plate part toward the terminal. This might increase the amount of heat generated at this end portion.

### SUMMARY

The present disclosure is feasible in the following aspects.

According to one aspect of the present disclosure, a terminal plate for fuel cell is provided. The terminal plate comprises: a plate body having a quadrilateral shape in a plan view and used for current collection; and a terminal provided at one side of the plate body, and including: a joint part joined to the plate body; and an output part joined to the plate body via the joint part. The joint part includes a first projection projecting in a first direction parallel to a direction in which the one side extends. The output part has a center in the first direction that is spaced apart from a center of the one side toward a second direction opposite to the first direction.

### BRIEF DESCRIPTION OF THE DRAWINGS

FIG. 1 is a perspective view showing a schematic configuration of a fuel cell where a terminal plate according to one embodiment of the present disclosure is used;

FIG. 2 is a plan view of the terminal plate;

FIG. 3 is a graph showing a relationship between the length of a first projection and a maximum temperature at a plate body;

FIG. 4 is a view schematically showing a flow of a current in a configuration according to a comparative example without the first projection; and

FIG. 5 is a plan view of a terminal plate according to another embodiment.

### DETAILED DESCRIPTION

### A. EMBODIMENT

### A1. Device Configuration

### <Schematic Configuration of Fuel Cell 100>

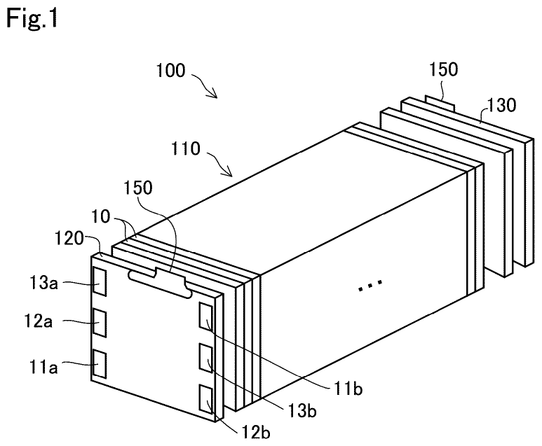

FIG. 1 is a perspective view showing a schematic configuration of a fuel cell 100 where terminal plates 120 and 130 according to one embodiment of the present disclosure are applied. The fuel cell 100 is mounted on a fuel cell electric vehicle (FCEV) and supplies power to a traction motor installed in the FCEV. The fuel cell 100 includes a stack 110, and the terminal plates 120 and 130 in a pair.

### <Configuration of Stack 110>

The stack 110 is configured by stacking a plurality of cells 10. For the sake of explanation, the stacked cells 10 are shown in a simplified manner in FIG. 1. The cell 10 is configured by stacking a fuel electrode, an electrolyte membrane, an air electrode, and a separator not shown in the drawings. The cell 10 generates power by being supplied with a fuel gas containing hydrogen and an oxidizing gas containing oxygen.

<Configuration of Terminal plates 120, 130>

The terminal plates 120 and 130 in a pair are arranged in such a manner as to interpose the stack 110 therebetween. Power generated by the cell 10 is collected in the terminal plates 120 and 130. The terminal plates 120 and 130 have mutually shapes symmetrical relative to the stack 110. The terminal plate 120 will be described below.

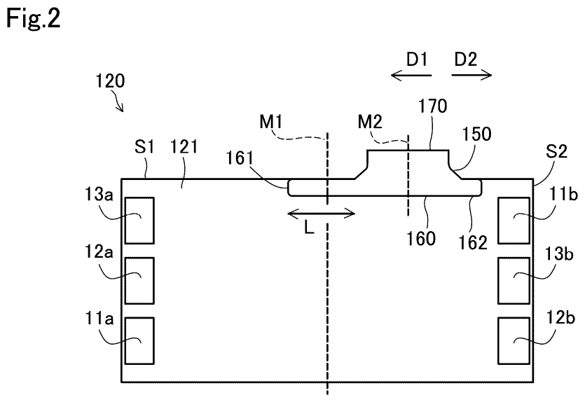

FIG. 2 is a plan view of the terminal plate 120. The terminal plate 120 includes a plate body 121 and a terminal 150. The plate body 121 has a quadrilateral shape in a plan view. In the present disclosure, the “quadrilateral shape” includes the rectangular shape and the nearly rectangular shape with corners rounded by R chamfering, for example. In the present embodiment, the plate body 121 has a rectangular shape in a plan view. The plate body 121 is used for collecting power generated by the stack 110. The plate body 121 is made of metal such as titanium or stainless steel. The plate body 121 is provided with a plurality of holes 11a, 11b, 12a, 12b, 13a, and 13b. Each of these holes 11a, 11b, 12a, 12b, 13a, and 13b constitutes a respective portion of the manifold extending in a stacking direction, and not shown in the drawings. Each of these holes 11a, 11b, 12a, 12b, 13a, and 13b is supplied with cooling water, the oxidizing gas, or the fuel gas. As an example, the hole 11a is used for supplying the cooling water and the hole 11b is used for discharging the cooling water. The hole 12a is used for supplying the oxidizing gas and the hole 12b is used for discharging the oxidizing gas. The hole 13a is used for supplying the fuel gas and the hole 13b is used for discharging the fuel gas.

The terminal 150 is provided at one side (long side) S1 of the plate body 121. The terminal 150 is located on a surface of the plate body 121 on an opposite side to the stack 110. The terminal 150 is made of metal such as aluminum or copper. The terminal 150 has a specific resistance smaller than the electrical resistance of the plate body 121. Specifically, electricity flows more easily through the terminal 150 than through the plate body 121. Thus, electricity collected at the plate body 121 flows toward the terminal 150. In the present embodiment, the terminal 150 has a T-shape in a plan view. The terminal 150 includes a joint part 160 and an output part 170.

The joint part 160 is a part where the terminal 150 is joined to the plate body 121. The joining is realized by a welding method using an arbitrary technique. The joining is realized by laser welding, arc welding, resistance welding, or friction stir welding, for example. A center of the joint part 160 along the one side S1 of the plate body 121 is offset from a center M1 of the one side S1 in the direction along the one side S1. The joint part 160 includes a first projection 161 and a second projection 162.

The first projection 161 projects in a first direction D1. The first direction D1 is a direction parallel to a direction in which the one side S1 of the plate body 121 extends. The first direction D1 is toward the center M1 of the one side S1 of the plate body 121. The first projection 161 is entirely joined to the plate body 121. In the present embodiment, a tip of the first projection 161 is located on the side of the first direction D1 relative to the center M1 of the one side S1 of the plate body 121.

The second projection 162 projects in a second direction D2. The second direction D2 is a direction opposite to the first direction D1. The second projection 162 is entirely joined to the plate body 121. In a direction parallel to the first direction D1 and the second direction D2, the length of the first projection 161 is greater than the length of the second projection 162. The lengths of the first projection 161 and the second projection 162 in the direction perpendicular to the first direction D1 and the second direction D2 are sufficiently smaller than the length of the plate body 121 in the direction perpendicular to the first direction D1 and the second direction D2.

The output part 170 outputs power generated by the fuel cell 100 to the outside. The output part 170 projects in a direction parallel to a short side S2, which is a direction spaced apart from the plate body 121. In other words, the output part 170 is the portion of the terminal 150 that does not overlap with the plate body 121. It may also be said that the output part 170 is not directly joined to the plate body 121 but is joined to the plate body 121 via the joint part 160. At a connection of the output part 170 to the joint part 160, the output part 170 has a shape gradually reduced in width from a side closer to the plate body 121 toward a side farther from the plate body 121. The width at the tip end of the output part 170 is uniform. In the present disclosure, the “width” shows a length in the direction parallel to the first direction D1 and the second direction D2. In the present disclosure, the output part 170 has a center M2 in the first direction D1 that is spaced apart from the center M1 of the one side S1 of the plate body 121 toward the second direction D2. In other words, the center M1 of the plate body 121 and the center M2 of the output part 170 are at positions shifted from each other in the first direction D1. In the present embodiment, the output part 170 is entirely spaced apart from the center M1 of the one side S1 of the plate body 121 toward the second direction D2. In other words, the center M1 does not pass through the output part 170.

### A2. Reduction of Heat Generation Using First Projection 161

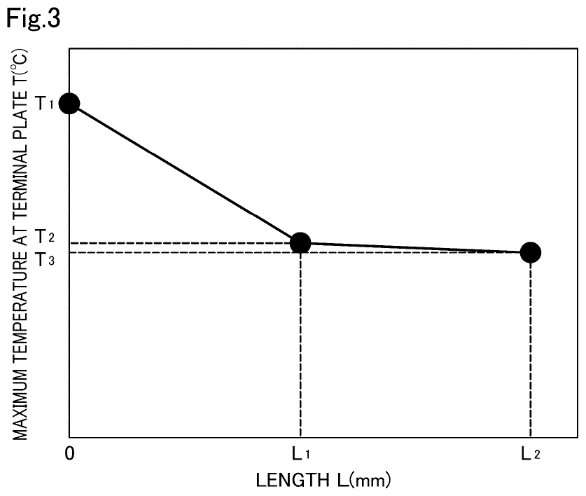

FIG. 3 is a graph showing a relationship between a length L of the first projection 161 and a maximum temperature T at the terminal plate 120. As shown in FIG. 2, with a length in the first direction D1 from an end portion of the output part 170 on the side of the first direction D1 to the tip of the first projection 161 defined as L, correlation between the length L and a maximum temperature at the terminal plate 120 was analyzed. Like the terminal plate 120 shown in FIG. 2, at the terminal plate 120 used for the analysis, the position of the output part 170 is at a position shifted from the center M1 of the one side S1 of the plate body 121. The terminal 160 in the terminal plate 120 used for analysis has the first projection 161. The analysis was conducted using CAE. The maximum temperature means the highest temperature among temperatures measured at respective points on the terminal plate 120 during supply of power by the fuel cell 100.

As shown in FIG. 3, in the absence of the first projection 161, namely, if the length L is 0, a maximum temperature at the terminal plate 120 was T1. The maximum temperature was observed at an end portion closer to the center M1 of the one side S1 of the plate body 121, among two end portions along the first direction D1 of the joint part 160.

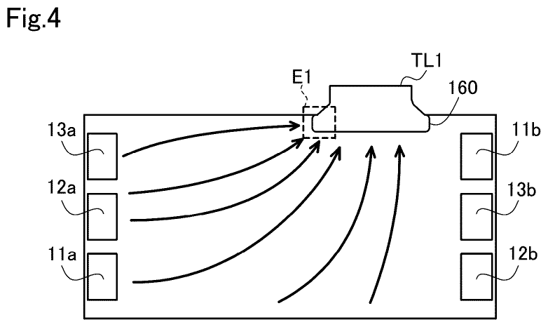

FIG. 4 is a view schematically showing a flow of a current in a configuration according to a comparative example without the first projection 161. As shown in FIG. 4, in the configuration of the comparative example, a current in the plate body 121 tries to flow to a terminal TL1 along a shortest path. In this case, if the position of the terminal TL1 is shifted from the center M1 of the one side S1 of the plate body 121, the current is concentrated at an end portion E1 of the joint part 160 in a direction opposite to a direction in which the terminal TL1 is shifted. This is considered to generate a large amount of Joule heat and to result in the maximum temperature observed at this site in the terminal plate 120.

As shown in FIG. 3, in the presence of the first projection 161 having a length L1, a maximum temperature at the terminal plate 120 was T2 lower than the above-described temperature T1. The maximum temperature was observed in the vicinity of the tip of the first projection 161.

In the presence of the first projection 161 having a length L2 greater than the length L1, a maximum temperature at the terminal plate 120 was T3 slightly lower than the above-described temperature T2. The maximum temperature was observed in the vicinity of the tip of the first projection 161.

Results of the analysis described above suggest that, compared to the configuration without the first projection 161, providing the first projection 161 makes it possible to reduce heat generation at the terminal plate 120. The results further suggest that, if the length L of the first projection 161 is increased, the effect of reducing heat generation is diminished gradually,

According to the terminal plate 120 of the above-described embodiment, the joint part 160 includes the first projection 161 extending in the first direction D1. Thus, compared to a configuration where the joint part 160 does not include the first projection 161, it is possible to suppress concentration of a current at the joint part 160, making it possible to reduce heat generation.

The center M2 of the output part 170 in the first direction D1 is spaced apart from the center M1 of the one side S1 toward the second direction D2. Thus, compared to a configuration where the center M2 of the output part 170 and the center M1 of the one side S1 are aligned with each other, it is possible to reduce the occurrence of interference between a member arranged in a periphery of a location of the fuel cell 100 and arranged at least partially in the vicinity of the center of the one side S1 (hereinafter also called a “peripheral member”) and the output part 170.

The joint part 160 includes the second projection 162. Thus, compared to a configuration without the second projection 162, it is possible to suppress concentration of a current at an end portion of the joint part 160 on the side of the second direction D2.

According to the terminal plate 120 of the embodiment, the length of the first projection 161 is greater than the length of the second projection 162 in the direction parallel to the first direction D1 and the second direction D2. Thus, it is possible to suppress concentration of a current at the joint part 160 on the side of the first direction D1 using the comparatively long first projection 161, making it possible to reduce heat generation.

According to the terminal plate 120 of the embodiment, the output part 170 is entirely spaced apart from the center M1 of the one side S1 of the plate body 121 toward the second direction D2. This allows the output part 170 to be located at a position spaced further apart from the center M1 of the plate body 121. As a result, it is possible to reduce the occurrence of interference further between the peripheral member and the output part 170.

According to the terminal plate 120 of the embodiment, at the connection of the output part 170 to the joint part 160, the output part 170 has a shape gradually reduced in width from a side closer to the plate body 121 toward a side farther from the plate body 121. Thus, compared to a configuration where the width of the output part 170 is uniform, it is possible to reduce the occurrence of a situation where the width of the output part 170 is changed suddenly. Thus, it is possible to suppress concentration of a current to flow from the joint part 160 into the output part 170, making it possible to reduce heat generation at the output part 170.

### B. OTHER EMBODIMENTS 1

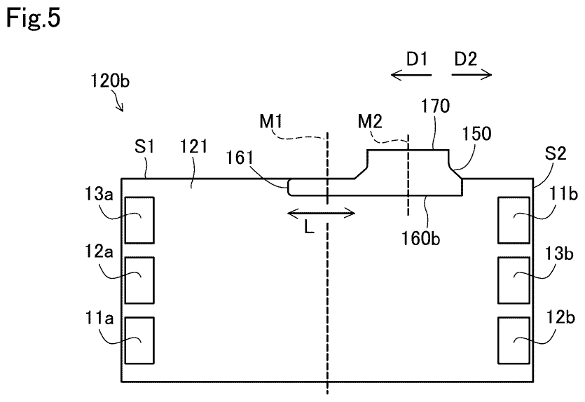

(B1) In the above-described embodiment, the joint part 160 includes the second projection 162. However, the present disclosure is not limited to this. FIG. 5 is a plan view of a terminal plate 120b according to another embodiment. As shown in FIG. 5, a joint part 160b may have a configuration including only the first projection 161 without the second projection 162. Even in this configuration, it is still possible to suppress concentration of a current using the first projection 161, making it possible to reduce heat generation.

(B2) In the above-described embodiment, the output part 170 is entirely spaced apart from the center M1 of the one side S1 of the plate body 121 toward the second direction D2. However, the present disclosure is not limited to this. The output part 170 may partially be spaced apart from the center M1 toward the second direction D2.

(B3) In the above-described embodiment, at the connection of the output part 170 to the joint part 160, the output part 170 has a shape gradually reduced in width from a side closer to the plate body 121 toward a side farther from the plate body 121. However, the present disclosure is not limited to this. The output part 170 may have an arbitrary shape. The output part 170 may have a shape where the width on the side closer to the plate body 121 and the width on the side farther from the plate body 121 are equal to each other, for example. The width of a portion of the output part 170 closer to the plate body 121 may be greater than the width of a portion of the output part 170 farther from the plate body 121.

### C. OTHER EMBODIMENTS 2

(C1) In the above-described embodiment, the terminal 150 is provided at the long side S1 of the plate body 121. However, the present disclosure is not limited to this. The terminal 150 may be provided at an arbitrary position along an outer periphery of the plate body 121. For example, the terminal 150 may be provided at the short side S2.

(C2) In the above-described embodiment, the plate body 121 has the long side S1 and the short side S2 and has a rectangular shape in a plan view. However, the present disclosure is not limited to this. The plate body 121 may have an arbitrary shape. For example, the plate body 121 may have a square shape in a plan view.

The present disclosure is not limited to the embodiments described above and is able to be realized with various configurations without departing from the spirit thereof. For example, the technical features in the embodiments are able to be replaced with each other or combined together, as appropriate, in order to solve part or the whole of the problems described previously or to achieve part or the whole of the effects described previously. When the technical features are not described as required features in the present specification, they are able to be deleted, as appropriate. The present disclosure may be realized in the following aspects, for example.

(1) According to one aspect of the present disclosure, a terminal plate for fuel cell is provided. The terminal plate comprises: a plate body having a quadrilateral shape in a plan view and used for current collection; and a terminal provided at one side of the plate body, and including a joint part joined to the plate body and an output part joined to the plate body via the joint part. The joint part includes a first projection projecting in a first direction parallel to a direction in which the one side extends. The output part has a center in the first direction that is spaced apart from a center of the one side toward a second direction opposite to the first direction.

According to the terminal plate of this aspect, the joint part includes the first projection extending in the first direction. Thus, compared to a configuration where the joint part does not include the first projection, it is possible to suppress concentration of a current at the joint part, making it possible to reduce heat generation.

The center of the output part in the first direction is spaced apart from the center of the one side toward the second direction. Thus, compared to a configuration where the center of the output part and the center of the one side are aligned with each other, it is possible to reduce the occurrence of interference between a member arranged in a periphery of a location of a fuel cell and arranged at least partially in the vicinity of the center of the one side and the output part.

(2) In the terminal plate of the above aspect, the joint part may further include a second projection projecting in the second direction, and the first projection may have a length greater than the length of the second projection in a direction parallel to the first direction and the second direction.

According to the terminal plate of this aspect, the joint part includes the second projection. Thus, compared to a configuration without the second projection, it is possible to suppress concentration of a current at an end portion of the joint part on the side of the second direction.

Furthermore, the length of the first projection is greater than the length of the second projection in a direction parallel to the first direction and the second direction. Thus, it is possible to suppress concentration of a current at the joint part on the side of the first direction using the comparatively long first projection, making it possible to reduce heat generation.

(3) In the terminal plate of the above aspect, the output part may entirely be spaced apart from the center of the one side of the plate body toward the second direction.

According to the terminal plate of this aspect, the output part is entirely spaced apart from the center of the one side of the plate body toward the second direction. This allows the output part to be located at a position spaced further apart from the center of the plate body. As a result, it is possible to reduce the occurrence of interference further between the peripheral member and the output part.

(4) In the terminal plate of the above aspect, at a connection of the output part to the joint part, the output part may have a shape gradually reduced in width from a side closer to the plate body toward a side farther from the plate body.

According to the terminal plate of this aspect, at the connection of the output part to the joint part, the output part has a shape gradually reduced in width from a side closer to the plate body toward a side farther from the plate body. Thus, compared to a configuration where the width of the output part is uniform, it is possible to reduce the occurrence of a situation where the width of the output part is changed suddenly. Thus, it is possible to suppress concentration of a current to flow from the joint part into the output part, making it possible to reduce heat generation at the output part.

What is claimed is:

1. A terminal plate for fuel cell comprising:
a plate body having a quadrilateral shape in a plan view and used for current collection; and
a terminal provided at one side of the plate body, and including: a joint part joined to the plate body; and an output part joined to the plate body via the joint part, wherein
the joint part includes a first projection projecting in a first direction parallel to a direction in which the one side extends, and
the output part has a center in the first direction that is spaced apart from a center of the one side toward a second direction opposite to the first direction.

2. The terminal plate according to claim 1, wherein
the joint part further includes a second projection projecting in the second direction, and
the first projection has a length greater than the length of the second projection in a direction parallel to the first direction and the second direction.

3. The terminal plate according to claim 1, wherein
the output part is entirely spaced apart from the center of the one side of the plate body toward the second direction.

4. The terminal plate according to claim 1, wherein
at a connection of the output part to the joint part, the output part has a shape gradually reduced in width from a side closer to the plate body toward a side farther from the plate body.
